(19) United States
(12) Patent Application Publication
(10) Pub. No.: US 2015/0225549 A1
(43) Pub. Date: Aug. 13, 2015

(54) METHOD FOR MANUFACTURING METAL NANOPARTICLES AND METHOD FOR MANUFACTURING METAL NANOPARTICLE INK BY SAME

(71) Applicant: SAMSUNG FINE CHEMICALS CO., LTD, Ulsan (KR)

(72) Inventors: Sung Soon Kim, Gyeonggi-do (KR); Eui Hyun Ryu, Daejeon (KR); Chan Hyuk Park, Seoul (KR); Kyung Yol Yon, Gyeonggi-do (KR)

(73) Assignee: SAMSUNG FINE CHEMICALS CO., LTD, Ulsan (KR)

(21) Appl. No.: 14/422,568

(22) PCT Filed: May 9, 2013
(86) PCT No.: PCT/KR2013/004107

§ 371 Date: Feb. 19, 2015

(30) Foreign Application Priority Data
Aug. 23, 2012 (KR) 10-2012-0092260

(51) Int. Cl. C08K 9/04; C09D 139/06; C07F 1/00; C09D 11/00

(52) U.S. Cl. CPC C08K 9/04; C09D 11/00; C09D 139/06; C07F 1/005

(57) ABSTRACT

A method of preparing metal nanoparticles for metal inks, and a method of preparing a metal nanoparticle ink using the same are provided. The method includes dissolving a metal precursor having a substituent at an α position, and applying an energy source or a mechanical force to the metal precursor solution. Also, the method includes preparing metal nanoparticles capable of adjusting an average particle size of the metal nanoparticles according to synthesis conditions, and preparing a metal nanoparticle ink by dissolving the prepared metal nanoparticles. Accordingly, the prepared metal nanoparticle ink can have improved dispersion stability and electric physical properties.

### TECHNICAL FIELD

The present invention relates to a method of preparing metal nanoparticles using a metal precursor prepared using a fatty acid having a substituent at an α position, and a method of preparing a metal nanoparticle ink using the same. More particularly, the present invention relates to metal nanoparticles capable of being easily dispersed in various solvents, controlling a particle size and particle distribution, exhibiting excellent dispersion stability, and improving physical properties of a coating film upon formation of the coating film, and a method of preparing a metal nanoparticle ink from the metal nanoparticles.

### BACKGROUND ART

A metal ink has been used for various products such as a conductive ink, an electromagnetic wave shielding agent, a reflective film forming material, an antibacterial agent, etc. In particular, conductive inks are used due to current regulations on use of lead in electric/electronic circuits, used for low-resistivity metal interconnections, printed circuit boards (PCBs), flexible printed circuit boards (FPCBs), antennas for radio frequency identification (RFID) tags and electromagnetic wave shielding materials, and are useful when a metal pattern is required or electrodes are simply formed in the field of new applications such as plasma display panels (PDPs), liquid crystal displays (TFT-LCDs), organic light emitting diodes (OLEDs), flexible displays and organic thin film transistors (OTFTs), and thus attention has been increasingly paid to the conductive inks. With the tendency toward highly functional and very thin electronic products, metal particles used in the electronic products are gradually becoming finer in size.

In general, metal inks have been prepared by producing a metal precursor or metal nanoparticles into ink.

Here, the metal nanoparticles have been prepared using a thermal decomposition method or a reduction method using a reducing agent. In this case, the metal nanoparticles have a problem in that they are not easily mixed in various solvents since a polar capping agent in a polymeric form is used.

Accordingly, the present inventors have conducted much research to find a way to solve the problems of the metal nanoparticles, and found that, when the metal precursor prepared using a fatty acid having a substituent at an α position is used to synthesize the metal nanoparticles, metal nanoparticles for metal inks capable of being easily mixed in various solvents, controlling particle size/distribution according to synthesis conditions and improving dispersion stability and physical properties upon formation of a coating film can be prepared. Therefore, the present invention has been completed based on these facts.

### DISCLOSURE

### Technical Problem

The present invention is directed to a method of preparing metal nanoparticles capable of controlling particle size and distribution of the various nanoparticles.

Also, the present invention is directed to a method of preparing a metal nanoparticle ink, which is able to be easily dispersed in various solvents and improve dispersion stability and physical properties of a coating film, using the metal nanoparticles prepared by the above-mentioned method.

### Technical Solution

According to an aspect of the present invention, there is provided a method of preparing metal nanoparticles for metal inks. Here, the method includes dissolving a metal precursor having a substituent at an α position in an organic solvent, and applying an energy source or a mechanical force to the metal precursor solution.

In the method of preparing metal nanoparticles according to the present invention, the metal precursor having a substituent at an α position may have a structure represented by the following Formula 1.

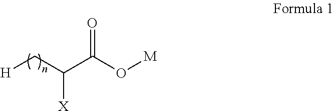

In Formula 1, X represents an alkyl group having 1 to 6 carbon atoms, or a halogen, M is selected from the group consisting of Ag, Pd, Rh, Cu, Pt, Ni, Fe, Ru, Os, Mn, Cr, Mo, Au, W, Co, Ir, Zn and Cd, and n is an integer ranging from 0 to 23.

Also, the organic solvent may be at least one selected from the group consisting of THF, xylene, toluene, methylene chloride, CH₃OH, CH₃CH₂OH, CH₃CH₂CH₂OH, ethylene glycol, diethylene glycol, triethylene glycol, propylene glycol, butylene glycol, diethylene glycol monomethyl ether, diethylene glycol monobutyl ether, propylene glycol monomethyl ether, and DMSO. In addition, at least one base selected from the group consisting of KOH, NaOH, NH₃, NH₂CH₃, NH₄OH, NH(CH₃)₂, N(CH₃)₃, NH₂Et, NH(Et)₂, NEt₃ and Ca(OH)₂ may be further included to enhance solubility in the dissolving of the metal precursor in the organic solvent.

The energy source applied to the metal precursor solution may be heat, microwaves or ultraviolet rays (UV), and the mechanical force applied to the metal precursor solution may be agitation or supersonic waves.

The metal precursor and the organic solvent may be present at a mass ratio of 1:2 to 1:5 to control the size of the nanoparticles to 20 to 200 nm, and be present at a mass ratio of 1:5 to 1:20 to control the size of the nanoparticles to 1 to 20 nm.

According to another aspect of the present invention, there is provided a method of preparing a metal ink. Here, the method includes synthesizing metal nanoparticles by dissolving a metal precursor having a substituent at an α position in an organic solvent and applying an energy source and a mechanical force to the metal precursor solution, mixing and dispersing an additive in the synthesized metal nanoparticles to adjust dispersibility and physical properties of the metal nanoparticles, and homogenizing the mixed solution.

The organic solvent used to disperse the metal nanoparticles may be at least one selected from the group consisting of an ether (THF, ethyl ether, propyl ether, or MEK), a benzene (xylene, toluene, ethylbenzene, or benzene), an alcohol (methanol, ethanol, butanol, propanol, ethylene glycol, or propylene glycol), a chloride (methylene chloride, or chloroform), a sulfide (DMSO), a nitride (DMF, DEF, ethylamine, ammonia, ethanol amine, diethanol amine, triethanol amine, or triethylamine), and an alkyl (hexane, pentane, or butane), and a dispersion stabilizer, a binder, and other additives may be known materials used to prepare a metal ink including the metal nanoparticles.

In the homogenizing of the mixed solution, supersonic agitation, eddy current agitation, mechanical agitation, a ball mill, or a roll mill may also be applicable.

### Advantageous Effects

The effects according to the present invention are described, as follows.

First, according to the exemplary embodiment of the present invention, the metal nanoparticles can be synthesized from the metal precursor using a fatty acid having a substituent at an α position. Accordingly, the metal nanoparticles are capable of being easily mixed in various polar solvents since a capping agent is a fatty acid having a substituent at an α position.

Second, a size and size distribution of the metal nanoparticles may be adjusted under the control of synthesis conditions (a concentration and a temperature) using various energy sources or mechanical forces to synthesize the metal nanoparticles.

Third, the metal nanoparticle ink having improved dispersion stability and ink physical properties may be prepared by adding a solvent and an additive at a suitable ratio to metal nanoparticles prepared according to the present invention.

### DESCRIPTION OF DRAWING

The above and other objects, features and advantages of the present invention will become more apparent to those of ordinary skill in the art by describing in detail exemplary embodiments thereof with reference to the accompanying drawings, in which:

FIG. 1 is a scheme showing a process of synthesizing a metal precursor having a substituent at an α position according to one exemplary embodiment of the present invention;

FIG. 2 is a schematic diagram showing a change in particle size under the control of synthesis conditions of metal nanoparticles prepared according to one exemplary embodiment of the present invention; and

FIGS. 3 to 5 are images illustrating the results of size control experiments on the metal nanoparticles prepared according to one exemplary embodiment of the present invention.

### BEST MODE

Exemplary embodiments of the present invention will be described in detail below with reference to the accompanying drawings. While the present invention is shown and described in connection with exemplary embodiments thereof, it will be apparent to those skilled in the art that various modifications can be made without departing from the scope of the invention.

The metal nanoparticles according to the present invention are prepared using a method which includes dissolving a metal precursor having a substituent at an α position in an organic solvent, and applying an energy source or a mechanical force to the metal precursor solution.

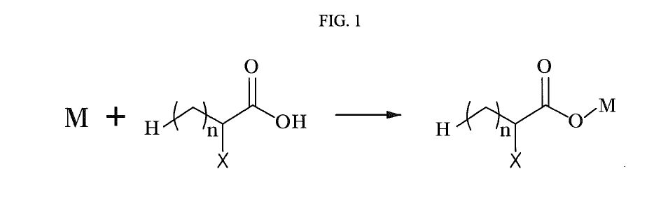

As shown in Scheme of FIG. 1, the synthesis of the metal precursor having a substituent at an α position is performed by allowing a fatty acid having a substituent at an α position dissolved in the organic solvent to react with a metal salt to synthesize a metal precursor having a substituent at an α position.

More particularly, the synthesis of the metal precursor includes preparing a fatty acid solution by dissolving a fatty acid having a substituent at an α position in an organic solvent; dropping a metal salt solution in the fatty acid solution to allow the metal salt solution to react with the fatty acid solution, forming a metal precursor precipitate from the mixed solution, and separating the precipitate.

In the preparation of the fatty acid solution by dissolving the fatty acid having a substituent at an α position in the organic solvent, the fatty acid having a substituent at an α position may have a structure represented by the following Formula 2.

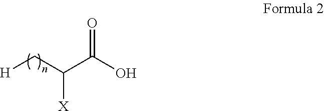

In Formula 2, X represents an alkyl group having 1 to 6 carbon atoms, or a halogen, and n is an integer ranging from 0 to 23.

The preferred fatty acid may be 2-methyl heptanoic acid, 2-methyl hexanoic acid, 2,2-dimethylbutyric acid, 2-ethylhexanoic acid, hexanoic acid, acrylic acid, or isobutyric acid.

Also, the solvent may be at least one selected from the group consisting of H₂O, CH₂CN, CH₃OH, CH₃CH₂OH, THF, DMSO, DMF, 1-methoxy-2-propanol, 2,2-dimethoxypropanol, 4-methyl-2-pentanone, pentanol, hexanol, nonane, octane, heptane, hexane, acetone, methyl ethyl ketone, methyl isobutyl ketone, methyl cellosolve, ethyl cellosolve, ethylene glycol, diethylene glycol, triethylene glycol, propylene glycol, butylene glycol, diethylene glycol monomethyl ether, diethylene glycol monobutyl ether, propylene glycol monomethyl ether, and dibutyl ether.

The fatty acid solution may further include at least one base selected from the group consisting of KOH, NaOH, NH₃, NH₂CH₃, NH₄OH, NH(CH₃)₂, N(CH₃)₃, NH₂Et, NH(Et)₂, NEt₃, and Ca(OH)₂.

In the reaction of the metal salt solution with the fatty acid solution by dropping the metal salt solution in the fatty acid solution, first, the metal salt solution is prepared by dissolving a metal salt in an organic solvent or an aqueous solution. In this case, an organic solvent used in the fatty acid solution may be used as the organic solvent, and the organic solvents used in the fatty acid solution and the metal salt solution may be the same or different.

Next, the metal salt solution is dropped in the fatty acid solution so as to react with the fatty acid solution. In this case, intense agitation may simultaneously accompany the dropping. Metal ions of the metal salt used herein may be selected from the group consisting of Ag, Pd, Rh, Cu, Pt, Ni, Fe, Ru, Os, Mn, Cr, Mo, Au, W, Co, Ir, Zn, and Cd, and Ag is more preferred. All of a nitride, an oxide, a sulfide and a halide may be used as an anionic material of the metal salt. Among these, the anionic material of the metal salt is preferably in the form of a nitride.

The fatty acid solution and the metal solution may be mixed at a volume ratio of 1:1 to 10:1 or 1:10. In this case, the volume ratio is the most preferably in a range of 1:1 to 1:10 or 10:1. Also the reaction may be performed at room temperature.

In the formation of the metal precursor precipitate from the mixed solution, the mixed solution in which dropping of the metal salt solution is completed may be further stirred for 1 to 30 minutes to form a precipitate.

In the separation of the precipitate, the precipitate may be removed using conventional separation methods known in the related art. More particularly, a method such as filtration or recrystallization may be used herein.

Subsequently, the separated precipitate may be washed several times with at least one selected from the group consisting of organic solvents used to synthesize the precipitate, for example, CH₂CN, CH₃OH, CH₃CH₂OH, THF, DMSO, DMF, 1-methoxy-2-propanol, 2,2-dimethoxypropanol, 4-methyl-2-pentanone, pentanol, hexanol, nonane, octane, heptane, hexane, acetone, methyl ethyl ketone, methyl isobutyl ketone, methyl cellosolve, ethyl cellosolve, ethylene glycol, diethylene glycol, triethylene glycol, propylene glycol, butylene glycol, diethylene glycol monomethyl ether, diethylene glycol monobutyl ether, propylene glycol monomethyl ether and dibutyl ether, and water, and then dried to form a final metal precursor.

In the dissolving of the metal precursor having a substituent at an α position prepared by the above-described method in the organic solvent, the organic solvent may be at least one selected from the group consisting of THF, xylene, toluene, methylene chloride, CH₃OH, CH₃CH₂OH, CH₃CH₂CH₂OH, hexane, ethylene glycol, diethylene glycol, triethylene glycol, propylene glycol, butylene glycol, diethylene glycol monomethyl ether, diethylene glycol monobutyl ether, propylene glycol monomethyl ether, and DMSO. Also, a base may be added to enhance solubility, and the base that can be used herein may include at least one selected from the group consisting of KOH, NaOH, NH₃, NH₂CH₃, NH₄OH, NH(CH₃)₂, N(CH₃)₃, NH₂Et, NH(Et)₂, NEt₃, and Ca(OH)₂.

Also, the particle size of the metal nanoparticles may be adjusted under the control of reaction conditions (a concentration, a temperature, etc.). For example, the average particle size of the metal nanoparticles may be controlled in a range of 20 to 200 nm under a condition in which the metal precursor and the solvent are present at a mass ratio of 1:5, or under a condition in which the metal precursor is present at a high concentration greater than the mass ratio of 1:5, for example, a high concentration of 1:2 to 1:5, and the average particle size of the metal nanoparticles may be controlled in a range of 20 nm or less under a condition in which the metal precursor and the organic solvent are present at a mass ratio of 1:5, that is, at a low concentration of 1:20, for example, a low concentration of 1:5 to 1:20. When the base is included, the sum mass of the solvent and the base may be applied instead of the solvent.

The temperature is maintained at 60° C. or less in both conditions of low and high concentrations. This is because compositions of the solution may be altered at a temperature greater than 60° C. due to volatilization of the solvent.

The particle size may be adjusted using a time parameter rather than a temperature parameter. For example, when a reaction time is an hour under a high-concentration condition, the metal nanoparticles having an average particle size of 50 nm may be obtained. However, the average particle size of the metal nanoparticles increases to approximately 100 nm with an increase in reaction time to 2 hours. However, when supersonic waves are applied at 60° C., the metal nanoparticles have a particle distribution of approximately 20 to 50 nm even when the reaction time increases to 2 hours. When a solvent having a low polarity and boiling point is used herein, a separation/purification process of the metal nanoparticles may be easily performed to simplify a process and increase a yield.

Subsequently, the metal precursor solution may be formed into metal nanoparticles by using various energy sources or applying a mechanical force. Here, the various energy sources that may be used herein may include heating at room temperature to 60° C., 3 to 10 kw microwaves, or ultraviolet rays (UV), and the mechanical force may be applied through eddy current agitation using equipment capable of realizing stable shaking within a range of 500 to 1,000 rpm, or equipment capable of realizing a driving power of 20 to 30 kHz.

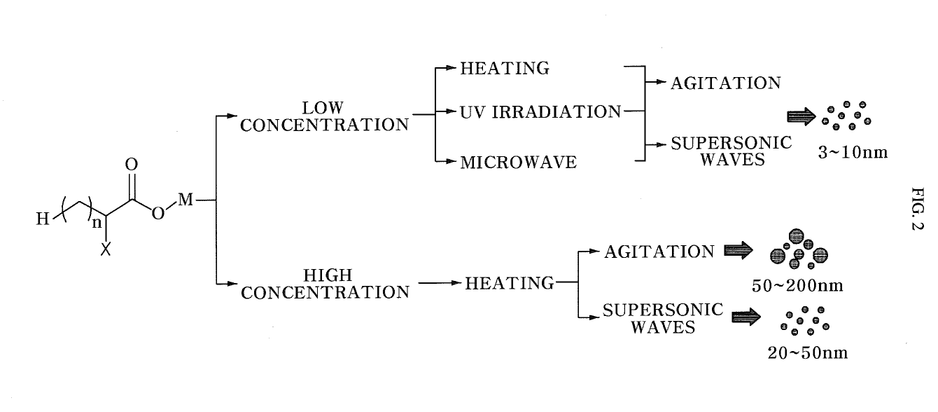

As shown in FIG. 2, when the metal precursor is present at a high concentration, nanoparticles having an average size of 50 to 200 nm may also be synthesized by applying heating at 60° C. and agitation to the mixed solution. Also, nanoparticles having an average size of 50 to 20 nm may also be synthesized by applying heating at 60° C. and supersonic waves to the mixed solution. On the other hand, when the metal precursor is present at a low concentration, nanoparticles having an average particle size of 3 to 10 nm may be synthesized by applying heating at 60° C., UV irradiation or microwaves, and agitation or supersonic waves to the mixed solution.

Also, the present invention provides a method of preparing a metal nanoparticle ink, which includes preparing a metal nanoparticle dispersion by dispersing the metal nanoparticles prepared by the above-described method in an organic solvent, mixing an additive to adjust physical properties, and homogenizing the mixed solution.

The organic solvent used to disperse the metal nanoparticles may be at least one selected from the group consisting of an ether (THF, ethyl ether, propyl ether, or MEK), a benzene (xylene, toluene, ethylbenzene, or benzene), an alcohol (methanol, ethanol, butanol, propanol, ethylene glycol, or propylene glycol), a chloride (methylene chloride, or chloroform), a sulfide (DMSO), a nitride (DMF, DEF, ethylamine, ammonia, ethanol amine, diethanol amine, triethanol amine, or triethylamine), and an alkyl (hexane, pentane, or butane), and a dispersion stabilizer, a binder, and other additives may be known materials used to prepare a metal ink including the metal nanoparticles.

In the mixing of the additive for adjusting physical properties, the physical properties of the final ink obtained by adding the additive required for a coating or printing process may be adjusted. General kinds of additives known in the related art may be widely used in a general content range. In the case of the additive used herein, for example, an amine, especially, NH₃, NH(CH₃)₂, N(CH₃)₃, NH₂Et, NH(Et)₂ or NEt₃, may be added at a content of 10 to 50% by weight, and a surfactant such as polyvinylpyrrolidone (PVP), polyacrylic acid (PAA), sodium dodecyl sulfate (SDS), Tween 20™ or DowFax™ may be added as a dispersion stabilizer at a content of approximately 0.05 to 5% by weight, based on the total weight of the final ink. Also, a thickener may also be added at a content of approximately 0.1% to 5% by weight, based on the total weight of the final ink.

In the homogenization of the mixed solution, the metal ink may be subjected to supersonic agitation, eddy current agitation, mechanical agitation or ball mill treatment. For example, the supersonic agitation may be performed for approximately 30 minutes to 2 hours at 5 to 50 Hz, the eddy current agitation may be performed for approximately 2 to 4 hours at 200 to 550 rpm, and the ball mill treatment may be performed by introducing balls and a solution at a weight ratio of 1:1 and stirring the solution for approximately 8 to 12 hours. Also, the roll mill treatment may be properly performed 1 to 9 times after the solvent and the additive are mixed at different ratios.

Hereinafter, the present invention will be described in further detail with reference to the following Examples. However, it should be understood that the description presented herein is not intended to limit the scope of the present invention.

### Example 1

### Preparation of Nm Nanoparticles Having an Average Particle Size of 3 to 10 nm

Synthesis of Ag Precursor

1.7 g of 2-methyl heptanoic acid was put into a 250 ml flask, and dissolved in 84 ml of a polar organic solvent, THF, and 2.7 g of NEt₃ was added as a base. Thereafter, 1.4 g of AgNO₃ was put into another 250 ml flask, and dissolved in 84 ml of THF. The AgNO₃ solution was slowly dropped in the 2-methyl heptanoic acid solution at a rate of 800 ml/hr while vigorously stirring. The mixed solution in which addition of the AgNO₃ solution was completed was stirred for 20 minutes, and a precipitate was separated, washed twice with an organic solvent (THF), and then dried to form 2.0 g of a Ag precursor (Ag-2-methyl heptanoate).

Preparation of Ag Nanoparticles

0.6 g of the Ag-2-methyl heptanoate was dissolved in 5.2 g of THF. Thereafter, 0.6 g of NEt₃ was added as the base, and stirred to enhance solubility. The resulting reaction solution was subjected to supersonic waves for an hour while heating at 60° C. to prepare Ag nanoparticles having an average particle size of 5 nm. The reaction solution was then separated by centrifugation, and the residual solvent was removed to prepare 0.2 g of Ag nanoparticles.

### Example 2

### Preparation of Nm Nanoparticles Having an Average Particle Size of 20 to 50 nm

Synthesis of Ag Precursor

A Ag precursor was prepared in the same manner as in the synthesis of the Ag precursor synthesized in Example 1.

Preparation of Ag Nanoparticles

0.6 g of the Ag-2-methyl heptanoate was dissolved in 2.2 g of THF and 0.6 g of NEt₃. Thereafter, the resulting reaction solution was subjected to supersonic waves for an hour while heating at 60° C. to prepare Ag nanoparticles having an average particle size of 30 nm. The reaction solution was then separated by centrifugation, and the residual solvent was removed to prepare 0.2 g of Ag nanoparticles.

### Example 3

### Preparation of Nm Nanoparticles Having an Average Particle Size of 50 to 200 nm

Synthesis of Ag Precursor

A Ag precursor was prepared in the same manner as in the synthesis of the Ag precursor synthesized in Example 1.

Preparation of Ag Nanoparticles

0.6 g of the Ag-2-methyl hexanoate was dissolved in 2.2 g of THF and 0.6 g of NEt₃. Thereafter, the resulting reaction solution was stirred at 60° C. for 1 to 2 hours to prepare Ag nanoparticles having a particle size distribution of 100 nm. The reaction solution was then separated by centrifugation, and the residual solvent was removed to prepare 0.2 g of Ag nanoparticles.

The Ag nanoparticles prepared in Examples 1 to 3 were photographed under a scanning electron microscope (SEM) to calculate an average particle size from particle sizes of 500 nanoparticles whose particle sizes were able to be identified.

### Example 4

### Preparation of Ag Nanoparticle Ink

0.6 g of each of the Ag nanoparticles prepared in Examples 1 to 3 was dispersed in 4.0 ml of an organic solvent (THF). Thereafter, an amine (NH₃) and a polyvinylpyrrolidone (PVP) were added as an additive and a dispersion stabilizer at content of 2% by weight and 0.5% by weight, based on the total weight of the mixed solution, and uniformly mixed by mechanical agitation to prepare a Ag ink.

### Experimental Example 1

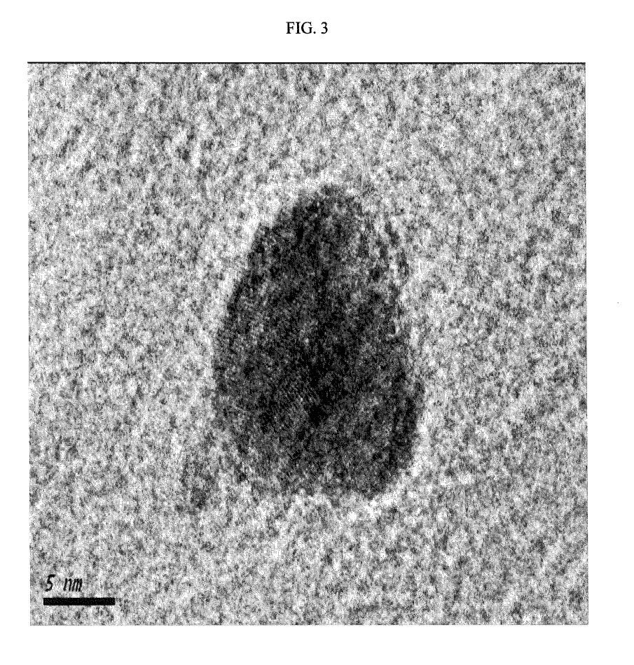

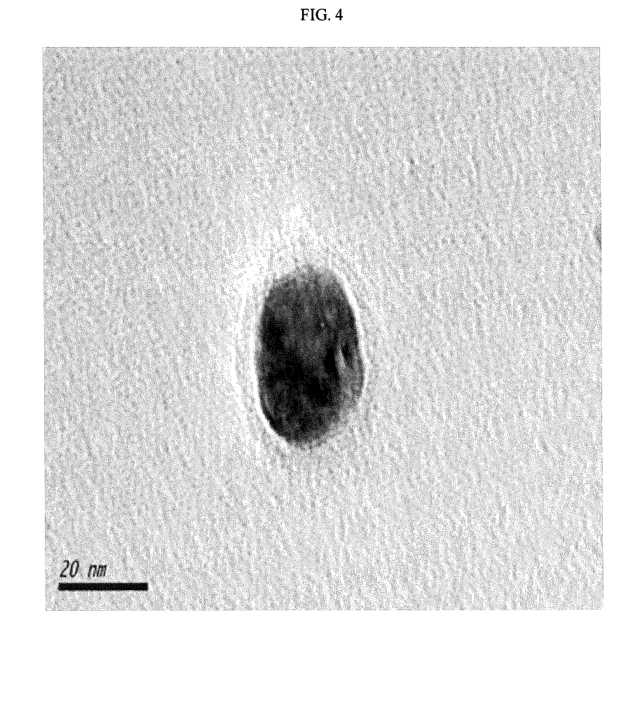

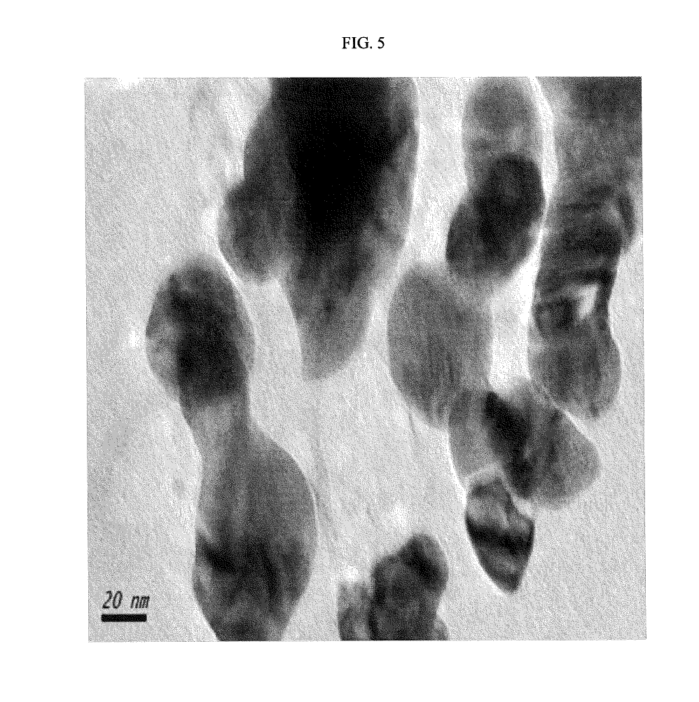

The Ag nanoparticles prepared in Examples 1 to 3 were photographed under a transmission electron microscope (TEM). The results are shown in FIGS. 3 to 5.

### Experimental Example 2

The Ag ink prepared in Example 4 was coated or printed, and sintered at 250° C. for 20 minutes. Thereafter, the coated coating film was measured for surface resistivity using a 4-point probe. As a result, it was revealed that the coating film had a specific resistivity of 7 μΩ·cm.

1. A method of preparing metal nanoparticles for metal inks, comprising: dissolving a metal precursor having a substituent at an α position in an organic solvent; and applying an energy source or a mechanical force to the metal precursor solution.

2. The method of claim 1, wherein the metal precursor having a substituent at an α position has a structure represented by the following Formula 1: 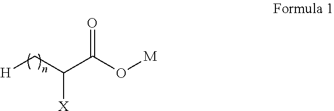
wherein X represents an alkyl group having 1 to 6 carbon atoms, or a halogen, M is selected from the group consisting of Ag, Pd, Rh, Cu, Pt, Ni, Fe, Ru, Os, Mn, Cr, Mo, Au, W, Co, Ir, Zn and Cd, and n is an integer ranging from 0 to 23.

3. The method of claim 1, wherein the organic solvent is at least one selected from the group consisting of THF, xylene, toluene, methylene chloride, CH₃OH, CH₃CH₂OH, CH₃CH₂CH₂OH, hexane, ethylene glycol, diethylene glycol, triethylene glycol, propylene glycol, butylene glycol, diethylene glycol monomethyl ether, diethylene glycol monobutylether, propylene glycol monomethyl ether, and DMSO.

4. The method of claim 1, wherein at least one base selected from the group consisting of KOH, NaOH, NH₃, NH₂CH₃, NH₄OH, NH(CH₃)₂, N(CH₃)₃, NH₂Et, NH(Et)₂, NEt₃ and Ca(OH)₂ is further included to enhance solubility in the dissolving of the metal precursor in the organic solvent.

5. The method of claim 1, wherein the energy source is heat, microwaves or ultraviolet rays (UV), and the mechanical force is agitation or supersonic waves.

6. The method of claim 1, wherein the metal precursor and the organic solvent are present at a mass ratio of 1:2 to 1:5.

7. The method of claim 1, wherein the metal precursor and the organic solvent are present at a mass ratio of 1:5 to 1:20.

8. A method of preparing a metal nanoparticle ink, comprising:
preparing a metal nanoparticle ink by dispersing the metal nanoparticles prepared by the method defined in claim 1 in an organic solvent;
mixing an additive to adjust physical properties; and
homogenizing the mixed solution.

9. The method of claim 8, wherein the organic solvent is at least one selected from the group consisting of an ether (THF, ethyl ether, propyl ether, or MEK), a benzene (xylene, toluene, ethylbenzene, or benzene), an alcohol (methanol, ethanol, butanol, propanol, ethylene glycol, or propylene glycol), a chloride (methylene chloride, or chloroform), a sulfide (DMSO), a nitride (DMF, DEF, ethylamine, ammonia, ethanol amine, diethanol amine, triethanol amine, or triethylamine), and an alkyl (hexane, pentane, or butane).

10. The method of claim 8, wherein supersonic agitation, eddy current agitation, mechanical agitation, a ball mill, or a roll mill is applicable in the homogenizing of the mixed solution.
